(19) United States
(12) Patent Application Publication
(10) Pub. No.: US 2008/0040428 A1
(43) Pub. Date: Feb. 14, 2008

(54) Method for establishing a social network system based on motif, social status and social attitude

(76) Inventors: Xu Wei, Shanghai (CN); Zhou Gang, Shanghai (CN)

Correspondence Address: WEINGARTEN, SCHURGIN, GAGNEBIN & LEBOVICI LLP, TEN POST OFFICE SQUARE, BOSTON, MA, 02109, US

(21) Appl. No.: 11/603,284

(22) Filed: Nov. 21, 2006

(30) Foreign Application Priority Data
Apr. 26, 2006 (CN) 200610026085.6

(51) Int. Cl. G06F 15/16

(52) U.S. Cl. 709/204

(57) ABSTRACT

An online social network for social partnering or friend-making includes describing the members within the online social network with theme, social position, and social attitudes and enables the members to classify and evaluate peers within the online social network corresponding to theme.

### CROSS REFERENCE TO RELATED APPLICATIONS

This application claims priority under 35 USC § 119(a)-(d) of Chinese patent application number 200610026085.6, filed on Apr. 26, 2006, which is incorporated herein in its entirety by reference.

### STATEMENT REGARDING FEDERALLY SPONSORED RESEARCH OR DEVELOPMENT

N/A

### BACKGROUND

In a social network, every actor, which can be an individual or an organization, must decide with which other actor(s) to interact. This is nontrivial when no central directories are available.

An example is a referral system, wherein each participant gives out referrals. Applicable domains of referral systems include business administration and knowledge administration. Research has used artificial intelligence methods to classify participants in a referral system into “service providers” and “consumers”, also putting forth evaluation metrics, relevant formulae and possible interaction policies in such a referral system. In such a referral system, referral activity can be defined as follows:

(1) a first node (e.g., a member) generates a question as to a certain theme for help;

(2) the first node selects some of the adjoining nodes as the receiving party for its request for help according to the selection standard stipulated by the first node, and such help can be the solution to the question or a referral to another node. In U.S. Pat. No. 7,069,308, the selection standard is degrees of separation. In US Patent Application 0060041543, the selection standard is search distance (which is another way of referring to degrees of separation) and degrees of familiarity;

(3) a receiving node, according to a criterion stipulated by the receiving node, or the social network, can a) provide a solution, or b) route the request for help to some of its adjoining nodes according to the selection standard described in (2), or c) refuse to provide help;

(4) the requesting node evaluates the solution it has acquired. For example, when an effective solution is acquired, the reputation of the provider node and the intermediate broker nodes are all enhanced.

Many social activities involve a routing process wherein a first member A of a social network searches an efficient path to his or her objective by consulting a second member B and/or more other members of the social network. This objective can be resources in one case, or congenial environment in another case. In this process, A usually considers the willingness and capability of B and/or others to provide resources.

There are drawbacks to the social consulting, information routing and referral system networks described above. For instance, concerns about privacy of information can limit sharing of information between members. Also, networks that rely on strong personal relationship ties between members for referral can limit information sharing within the confines of cliques and do not offer greatest access to information different from the general categories of information known within the clique. Therefore, a need exists for new methods of establishing social networking systems that can overcome these limitations.

### SUMMARY

The present invention relates to methods for establishing an online social network, describing the members within the online social network with theme, social position, and social attitudes, enabling the members to publish individual infos on capability, willingness, and scope to provide resources, and visibility range of such individual info, and to classify and evaluate peers within the online social network.

An embodiment of the invention provides a method for establishing an online social network that classifies the attributes of each member of the social network into sets of different themes and enables a member to select friends-to-be from other members according to their attributes of Social. Position and Social Attitudes.

A further embodiment enables a member of the social network to describe his or her capabilities and/or “social capital” in a certain field using a certain glossary, and to use such description as personal tag in the social network, and provides further for multiple members of, the social network to negotiate the glossary and classification using computing terminals and/or communication terminals.

The invention provides further for a member of the social network to describe his or her mode of social interaction in the clique of acquaintances of strong ties, the description able to be used on computing terminals and/or communication terminals to represent the Social Position that the member engages in his or her social interactions in the cliques formed by acquaintances of strong ties, and further provides for the social network to collect data related to the interaction mode among members and to represent the Social Position that the member engages in his or her social interactions in the clique formed by acquaintances of weak ties using such data on the computing terminals and/or communication terminals.

An embodiment of the invention provides for monitoring of a first member's reaction under preset situations of social interactions in order to describe the member's Social Attitude, and further for enabling said first member or another member to generate test questions for such use under the preset situations on computing terminals and/or communication terminals. In at least one preferred embodiment these test questions can be utilized (during generating and/or responding) to test characteristics or properties exhibited by the first member and/or another member. These characteristics or properties can be static or dynamic, and can include indications of attitude(s) generally and/or of Social Attitudes and Social Position as more particularly defined and used in the interactive process of the social network

The invention provides further for a method for establishing a social network system based on motif, social position and social attitude wherein trust is more related with referral and/or shared view/attitude rather than with shared friends/acquaintances, such that the limit of degree of familiarity can be omitted.

An embodiment further provides for a method for establishing a social network system based on motif, social status and social attitude wherein the at least first member in the social network is enabled to declare his or her role in social resource provision in a certain field, the first member can define which other second member and/or other members, and by what criteria, are entitled to information about the first member's capability, the first member can access resources in the part of the existing social network available to the first member, and the first member can access part(s) of the existing social network unknown to the first member previously.

Another preferred embodiment of the invention provides for an execution environment in a system that includes a personal tag server system comprising a number of personal tag servers, at least one other server system, and a clients system interconnected to a communications network, such as the Internet. Social attitude testing can be provided to a resource owner, middleman, and/or lobbyist and to a possible customer in order to evaluate each other's trustworthiness. History data of a percentage of transactions successfully closed can be used to measure trustworthiness and limitations on degrees of separation can be a prerequisite to ensure a certain degree of trustworthiness.

### BRIEF DESCRIPTION OF THE DRAWINGS

FIG. 1 illustrates aspects of an embodiment of the invention, including a flow chart of process steps in a method for establishing a social network system based on motif, social status and social attitude.

FIG. 2 illustrates an execution environment for an embodiment of the invention, including multiple server systems, clients and network.

FIG. 3 is a graphic depicting a social network according to the invention.

### DETAILED DESCRIPTION

Graphs and matrices are used to describe the relations among the members of social network. Each participant of the social network can be described as a node adjoining other nodes. At least one of the two adjoining nodes can contact the other of the pair directly. So the adjoining nodes represent two social actors who can interact with each other without relying on third party to act as broker.

A characteristic of the social network is that the Social Position and role of the participants can be inferenced using the network structure. The main grounds for such inference are that if two participants represent similar relation characteristics, then they have similar social roles and Social Positions. The index for measuring the above-mentioned similarity is “equivalence”, which can be divided into three kinds: structural equivalence, automorphic equivalence, and regular equivalence. The regular equivalence means that two participants have the same relation patterns with members or other participants, without considering the amount of the relation contacts. For example, a first mother and a second mother can be defined as “regular equivalents” because they have the same relation patterns with, for example, their husbands, children and in-laws.

Another characteristic of the social network is that the relationship of the identical dyad can be described by different “themes.” Themes (or motifs) are a first member's viewing perspectives of the multi-dimensional social relationship. For example, a first member's life experience can be divided into various aspects; a “theme” is a word or a term used to define one of the aspects.

The present application is intended to describe a social search mechanism. In the intended scenario, the searcher uses theme/motif as his searching key which describes the features of his target.

The invention provides a mechanism for neighbor selection, which is an indispensable process in a social network, whether this social network is a referral network or not.

The classification of adjoining nodes by an actor in a social network is a recurring scenario. This was typically implied in previous, conventional social networking referral systems developed around a single “theme”.

Previously, no referral systems have existed wherein the participants cannot be classified into service providers and consumers. One of the applicable domains, however, where it is desirable to allow node interactions beyond the limit of a two-class structure of service provider/customer is the social network. One example is a social network organized for people seeking a spouse, mate or social partner (hereinafter termed a “dating social network”).

It should be understood that in the discussion herein the dating social network is used as a possible user scenario of the present invention instead of a restrictive description of the possible applicable domains of the present invention. It also should be understood that the detailed technique and/or technology mentioned in the following discussion not be regarded as the restrictive description of the applicable domain of the present invention.

A member of a dating social network selects a possible mate or relationship partner according to Social Position and Social Attitude, among other criteria, such as, for example, physical characteristics. Social Position, in the present context, refers to the professional and/or political position a member owns, and possibly position a member holds in various groups in which he or she volunteers, wherein he or she shares the same hobbies with other group members. Social Attitude refers to the set of choices the member shall make in various social situations (realistic and/or imagined). Owing to different friend-making policy (for example, position-first or attitude-first, exception making, and considerations as to privacy protection), members of the dating social network exhibit different priority and pace as to the disclosure of different facets of their private information, as well as to the disclosure of different facets of others' private information. In the meantime, due to the importance of creditability of private information, a member of the dating social network will evaluate the creditability of obtained info through many available approaches. The different criteria of creditability of different members of the dating social network is a sound reason why the dating social network can not be deemed a referral system consisting of service providers and consumers.

Regular equivalence as described above is a suitable metric of Social Position. Regular equivalence can be used to describe a member's Social Position, and in the meantime can protect the member's privacy in a certain period of information disclosure. For example, when a member is known to receive information from and to send no information to one kind of role (“subordinate”) and/or send information to and receive no information from another kind of role (“boss”), then any increment of details in description of “boss” and “subordinate” will render a greater increment in knowledge about the member's Social Position in his or her profession without going into details of private information (for example, the member's title and salary). In this way, the system according to the invention can be devised using directed graph methods derived from graph theory to describe the mode in which a social actor interacts with his or her “boss” and/or “subordinate” in an environment defined by a “theme” (such as, for example, “profession”) in a realistic or virtual society. Such description method satisfies the need of a member to make himself or herself briefly known without disclosure of too much private information.

In a dating social network, it is a recurring scenario that a member demand his or her counterpart to make hypothetical or real choices in some interaction characteristic of interpersonal relation situations that are similar to or the same as those situation which might occur in future, in order to test the Social Attitude of the counterpart. One of the traditional methods to explore Social Attitude is psychological tests to record the test subject's reactions under preset situations. Owing to the expertise needed to devise the tests this approach is seldom adopted by ordinary people. However, modern communication means make wide use of this approach possible.

Therefore, the present invention differs from the prior art in that, whether or not a social network can be defined as a referral system consisting of “service providers” and “consumers”, members in the social network are described on the basis of “theme”, Social Position, and Social Attitudes, in order to facilitate members' classification and selection of each member's adjoining nodes in the social network.

The term “theme” in this context is to be understood as a key word related to the mission or task that a person would like to realize in his or her social network. When such a person scrutinizes his or her social network under different “themes” (tasks or missions), then the geodesic solutions are different (i.e., solutions that relate to finding the shortest or least-energy path in a real space, or in a mathematical space, such as, for example, a graph-theoretic space, are different based on the thematic environment). That is, the connecting mode of nodes and the distance between the nodes can be drastically changed.

It can be stated that the Social Positions of this person's acquaintances in this social network are different under each different “theme” (or under each different task or mission). Therefore, the “theme” and “Social Position” are delimiters of a person's social network.

To accomplish a task or mission in a social environment in an acceptable time period (or within an acceptable cost window), it can be understood that a potential difference in Social Positions is advantageous.

The Social Attitude is a person's reaction under a social context or a social situation, which requires the person to make conscious and/or subconscious decisions as to whether to share his or her resources. Such resources may constitute a kind of power within his or her own control, or a kind of access right to another highly positioned person.

In practice, a person must make a subjective estimate of his or her social network as per his or her “theme” (task or mission); however, this subjective estimate may be drastically different from the reality. Until the method described here according to an embodiment of the invention, no such tools have existed for a person to estimate the difference between the subjective estimate and the reality.

For example, is the potential difference of the key person large enough? Is the key person willing to interact with the person as expected (maybe in search of social fame)? Or is there another person (a “broker”) willing to act as an introducing intermediary to this key person? If so, what is the possible broker seeking?

Where a first member A of a social network searches an efficient path to his or her objective by consulting a second member B and/or more other members of the social network, the willingness of B and/or others to provide resources to A is usually equated to the intensity of social relationships, or tie strength. The strength of relationships (or “ties”) is typically expressed in terms of “weak measure” versus “strong measure”, where close and intimate social relationships are referred to as strong ties, and more superficial ones are weak ties. The strength of weak ties is related to the following rationale: people with characteristics different from A may give to A access to information and resources that are different from those resources personally owned by A. It is postulated in a strength-of-weak-ties proposition that social capital resulting from weak ties brings advantages in situations associated with instrumental actions, where resources dissimilar to one's own resources are important. However, the effectiveness of weak ties is hypothesized to be contingent on one's own position, with smaller positive effects expected for those with very low or very high prestige.

As to the capability to provide resources, B and/or others can be divided into resource owner, middleman, and lobbyist. As a study has shown, participants who are successful in reaching their target within six degrees of separation utilize the difference in potential energy among people. However, A's role in providing resource is different in different fields. For example, a computer expert may be a poor linguistics student and a good gardener. A usual routing approach is to find member B (and/or other members) who possesses (or possess, respectively) a “favored position” in a social network, where “a favored position measure” is defined by degrees of centrality, closeness centrality and betweenness centrality (“betweenness” is related to the numbers of paths between two nodes on which a member engages an intermediate position). These centrality metrics might be criticized because they do not take into account that strength of relationships and positions may be different in different fields, with respect to different resources, and probably a mean value might be meaningless.

A question will exist as to whether the willingness of B and/or others to provide resources and, to an extent, to trust is efficiently measured by social distance or degrees of separation. An identical B (and/or others) may be willing to provide one kind of resource to A, but meanwhile may be unwilling to provide another kind of resource to A. From another perspective, A may disclose his social role as resource owner/middleman/lobbyist to B (and/or others) according to social distance between A and B and/or others, which can be measured by degrees of separation or degree of familiarity. Or A may do so according to other metrics, such as, for example, social attitudes. The graph of A's social network, the distance of the path between the same two nodes, independent of metrics, will be of different value under different themes/motifs (or topics).

The invention provides an approach to access social resources thru weak ties. A first member A in the social network claims his/her role in social resource provision in a certain field. Further, A can define which other second member B (and/or other members), by, what criteria, are entitled to information about A's capability. By this approach, the A can not only access resources in the part of the existing social network available to A, but also can route to the part(s) of existing social network unknown to A previously.

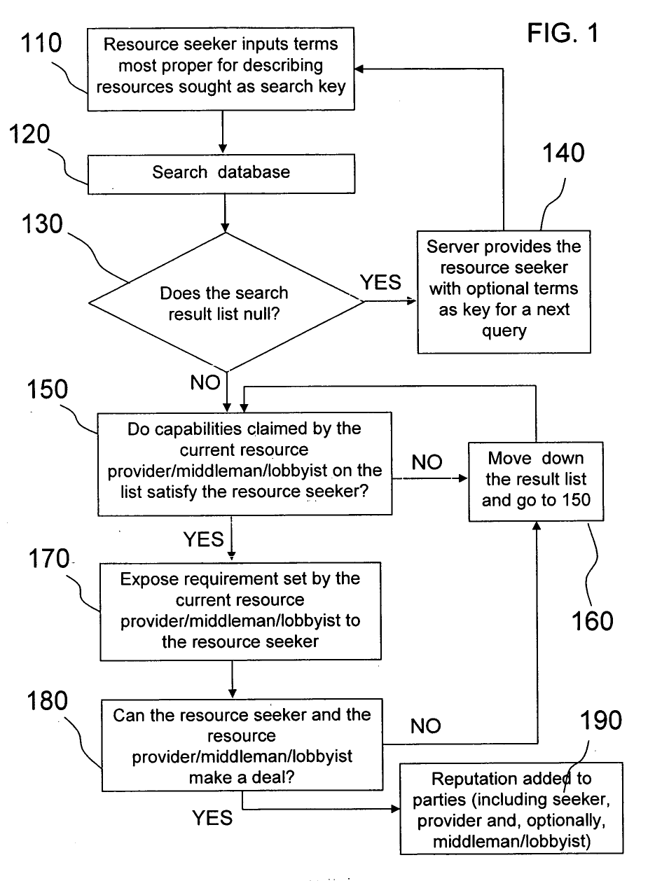

Turning now to FIG. 1, further details of a preferred embodiment of the invention can be illustrated. At Step 110, the resource seeker inputs key search terms (such as, for example, keywords) that are regarded to be most proper for describing the resources sought. From step 110, the process continues to Step 120. At Step 120, the system searches the database for records that correspond to and/or relate to the key search terms. This can be a fully automated search or it can be a user-supervised search (which may include semi-automated sub-steps whereby the search can be further focused and/or optimized). From Step 120 the process continues to Step 130.

At Step 130, the program code tests the search results list to see if it is null. The process can continue in two directions depending on the outcome at Step 130. If the results are null (the process returns a “yes” decision), then the process moves to Step 140. At Step 140, the server provides the resource seeker with optional terms as keywords for a next query (or an iterative query), whereupon, from Step 140, the process returns to Step 110. If at Step 130 the search result list is not null, so that the process returns a “No” decision, then the process moves to Step 150.

At Step 150, the process displays an entry or record from the result list, which indicates capabilities claimed by a current resource provider, middleman and/or lobbyist and queries the user: “Do the capabilities claimed by the current resource provider, middleman, and/or lobbyist on the list satisfy the resource seeker?” The process continues in two directions depending on the outcome at Step 150. If at Step 150 the answer to the query is “No,” then the process moves to Step 160. Step 160 moves down the result list to the next entry or record and the process returns to repeat Step 150. If the end of the list is reached the user is notified and the process can be terminated or redirected by the user (such as restarting at Step 110). If at Step 150 the answer is “Yes,” then the process moves to Step 170.

At Step 170, the process exposes to the resource seeker the requirements set by the current resource provider, middleman, and/or lobbyist. The process then moves to Step 180, where the resource seeker and the resource provider, middleman and/or lobbyist are queried as to potential capability and/or interest (willingness) to make a deal. This query step can be multi-staged and/or semi-automated, where one or both parties may have entered predetermined criteria for a deal being made and the process tests the requirements of both parties, or where one or both of the parties is queried interactively, either immediately or upon some preset schedule, as to willingness and decision to enter into a deal, partnership or other relationship.

From Step 180 the process can continue in two directions, depending on the outcome of the queries that test for deal potential. If at Step 180 the answer is “No”, i.e., the seeker and provider cannot make a deal, then the process returns to Step 160. If at Step 180 the answer is “Yes”, then the process continues to Step 190.

At Step 190 reputation is added to the parties, including to the seeker and to the provider and optionally to the middleman and/or lobbyist.

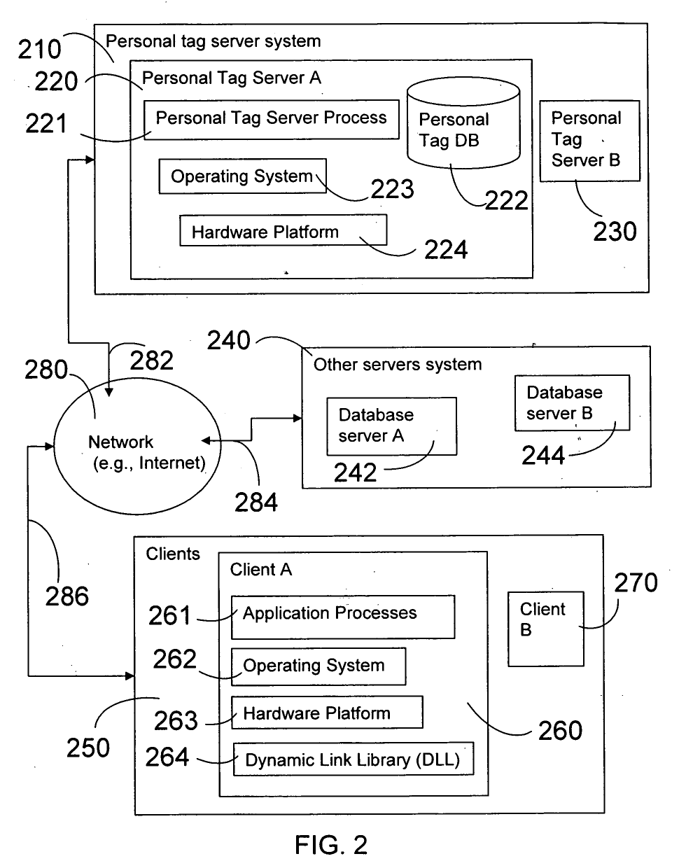

Referring now to FIG. 2, a preferred embodiment of the invention provides for an execution environment in a system according to the invention that includes a personal tag server system 210 comprising a number of personal tag servers, at least one other server system 240, and clients system 250, interconnected to a communications network 280, such as, e.g., the Internet. The personal tag server system 210, for purposes of illustration, can include a first personal tag server 220 and a second personal tag server 230, and may include any number of additional personal tag servers. Each personal tag server can include a personal tag process 221, a personal tag database 222, an operating system 223, and a hardware platform 224, inter alia. The hardware platform 224 may include programs transmittable through connections 282 and through the interconnecting network 280, and executable on clients 250, which clients may be computers, mobile telephones, and/or other client devices.

The at least one other server system 240, for purposes of illustration, can include a first database server 242 and a second database server 244, and may include any number of additional database servers.

The clients system 250, for purposes of illustration, can include a first client 260 and a second client 270, and may include any number of additional clients. Each client includes a number of application processes 261, an operating system 262, a hardware platform 263, and a dynamic link library 264.

One embodiment of the disclosed method utilizes the wiki tool or its like (for example, a type of collaborative software and/or website tool for collaborative authoring that allows visitors themselves to easily add, remove and otherwise edit and change some available content, sometimes without the need for registration). A resource owner, middleman and/or lobbyist may start a theme describing his position on this topic, his requirement of possible future customer on trustworthiness, and transaction terms he expected. Each entry committed by a certain resource owner, middleman, and/or lobbyist may be regarded as a blog (or weblog, being a type of website where entries are made, such as in a logbook or diary, displayed in chronological or reverse chronological order, typically combining text, images, and links to other blogs, web pages, and other media related to its topic). These blogs may be indexed into a personal tag database 222.

Theme, position, and trustworthiness are fields of the personal tag database 222. Most nouns in an encyclopedia may be used as a keyword.

There exist many possible delimiters of social position. In one embodiment of the disclosed method, betweenness centrality is used as at least one descriptive characteristic of a resource owner, middleman and/or lobbyist.

In one embodiment of the disclosed method, social attitude testing is provided to a resource owner, middleman, and/or lobbyist and to a possible customer in order to evaluate each other's trustworthiness. In another embodiment of the disclosed method, history data of a percentage of transactions successfully closed may be utilized as a tool to measure trustworthiness. In another embodiment of the disclosed method, limitations on degrees of separation may be utilized as a prerequisite to ensure a certain degree of trustworthiness.

One embodiment of the present application provides for a person to apply for a telecommunication service by providing his or her identification document and filling out necessary forms. After conceding to an exemption declaration made by service providers, he is entitled to the telecommunication service, which saves the phone number of the person's contacts on the server, and allow the applicant to name a theme which symbolizes an activity in which (1) the applicant is listed as possessing certain capabilities and being willing to provide service to others and/or (2) the applicant is listed as being acquainted with someone who possesses certain capabilities in this activity and is willing to provide brokering service to the others. Additionally, the telecommunication service allows the applicant to specify which persons in his contact list saved on the server are entitled to access and/or utilize the capabilities information described above, and which ones are not. By this means, the notion of “A is the neighborhood of B” in a field symbolized by a theme is implemented. When one of the applicant's contacts tries to reach the applicant, the applicant's phone number is available on a computing terminal or a communicating terminal to the contact. Also available is one or several tags, which could be voice tags or graph tags, specifying the activity fields in which the applicant is willing to provide service to the contact. The contact can apply for such service thru pre-set means, e.g., a speed-dialing number.

Through similar means, one applicant can also specify in a certain field of activity that he is related in a subordinate relationship to certain contacts, from whom he obtains instructions and submits reports. A person familiar with the field of activity will be able to obtain information about the applicant's social status. One of the feasible methods to express such information is by a directed graph. For instance, A and B can be two neighboring nodes in a directed graph, and a unidirectional arrow from A to B can symbolize that B obtains instruction from A, while A does not obtain instruction from B. Such graphs comprising unidirectional arrows are able to be shown on a computing terminal or a telecommunication terminal.

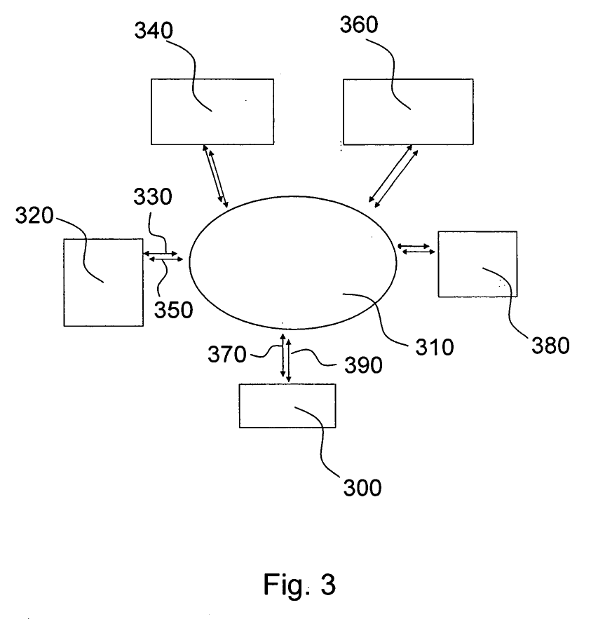

Referring to FIG. 3, an embodiment of the invention can provide for a social network system in which an individual 300 can be provided access to a social network service provider 310. The system can provide individual 300 with a graphic view of the network, such as, for example, the graphic provided by FIG. 3 itself, which can be displayed on a computer terminal. Bidirectional arrows 370 and 390 depict multiple pathways or “channels” of information flow, information exchange, instructions, and monitoring, inter alia, between service provider 310 and individual 300. For example, one arrow can represent monitoring of the reactive behavior of individual 300 under preset situations of social interactions in order to describe Social Attitude. It will be appreciated by one skilled in the art that in alternative embodiments each of these arrows can alternatively be bidirectional or unidirectional in the context of instructions, requests, questions or other type of directed flow of information. Also, it will be appreciated that more arrows can be added to depict additional channels of information flow or exchange, and/or other graphic methods can be utilized to represent such channels of information flow.

Still referring to FIG. 3, another person in the social network, for example Contact One 320, with access to the same provider 310, can be can be distinguished by and/or can be designated as having a first theme. Contact One 320 can also have a status graph showing information about the status of Contact One, which graph can be displayed graphically on a computer terminal. Bidirectional arrows 330 and 350 depict multiple pathways or “channels” of information flow, information exchange, instructions, and monitoring, inter alia, between service provider 310 and Contact One 320. Similarly, the social network provider 310 can provide connection to additional persons characterized by other themes, such as Contact Two 340 characterized by a second theme, Contact Three 360 characterized by a third theme, and Contact Four 380 characterized by a fourth theme. It will be appreciated that the network allows all the networked participants to exchange information through the network service provider 310, such that the channels of information exchange can be made to operate directly between any two or more participants. Thus individual 300 can communicate with one or more contacts simultaneously and/or sequentially.

While the present invention has been described in conjunction with a preferred embodiment, one of ordinary skill, after reading the foregoing specification, will be able to effect various changes, substitutions of equivalents, and other alterations to the compositions and methods set forth herein. It is therefore intended that the protection granted by Letters Patent hereon be limited only by the appended claims and equivalents thereof.

Additionally, it will be appreciated that many aspects of implementing communications networks in the context of social networks are known to those skilled in the art and that a subset of those aspects can be utilized in the context of the present invention to provide the embodiments described herein. In this regard, the following references are provided and are hereby incorporated by reference in their entirety into this application.

### REFERENCES

1. Introduction to Social Software for the Networked Social Enterprise, Lee Bryant, Mar. 31, 2005, http://www.headshift.com
2. Folksonomies—Cooperative Classification and Communication through Shared Metadata, Adam Mathes, December 2004
3. Social Bookmarking Tools, Tony Hammond, Timo Hannay, Ben Lund, and Joanna Scott, April 2005
4. At the Crossroads of Knowledge Management with Social Software, Gabriela Avram, Interaction Design Center, University of Limerick, Limerick, Ireland
5. United States Patent Application 20050166154, Enhanced Instant Message Status Message Area Containing Time/date Stamped Entries and Editable by Others, Richard M. Wilson et al., Jul. 28, 2005
6. United States Patent Application 20050165880, Method and System for Sensing and Communicating Updated Status Information for Remote Users Accessible through an Instant Messaging System, Paul B. Moody et al., Jul. 28, 2005
7. United States Patent Application 20050234781, Method and Apparatus for Word of Mouth Selling via a Communications Network, Jared Morgenstern et al., Oct. 20, 2005
8. U.S. Pat. No. 6,269,369, Networked Personal Contact Manager, Brian D. Robertson, Jul. 31, 2001
9. United States Patent Application 20040215793, Personal Contact Network, Grant James Ryan, Oct. 28, 2004
10. United States Patent Application 20030088480, Enabling Recommendation Systems to Include General Properties in the Recommendation Process, Frank Berghofer et al., May 8, 2003
11. Social Networks Research Report, Wildbit LLC., http://tidbit.wildbit.com, Jul. 25, 2005
12. Reputation, Trust and the Coordination of Communities of Practice, Paul Muller (Ph.D. thesis), Dec. 13, 2004
13. Groups in Social Software: Utilizing Tagging to Integrate Individual Contexts for Social Navigation, Kai Bielenberg and Marc Zacher (Master thesis), Aug. 16, 2005
14. United States Patent Application 20060031203, Periodic Update of Data in a Relationship System, Andrew Michael Rosenbaum et al., Feb. 9, 2006
15. United States Patent Application 20050243736, System, Method, and Service or Finding an Optimal Collection of paths among a Plurality of Paths between Two Nodes in a Complex Network, Christos Faloutsos, Nov. 3, 2005
16. United States Patent Application 20050060287, System and Method for Automatic Clustering, Sub-clustering and Cluster Hierarchization of Search Results in Cross-referenced Databases Using Articulation Nodes, Ziv Z. Hellman et al., Mar. 17, 2005
17. Towards Decentralized Recommender Systems, Cai-Nicholas Ziegler (Doctoral thesis), Feb. 17, 2005
18. United States Patent Application 20050256756, System and Method for Utilizing Social Networks for Collaborative Filtering, Chuck P. Lam et al., Nov. 17, 2005.
19. United States Patent Application 20050131897, Method and System for Expertise Mapping Based on User Activity in Recommender Systems, Antonietta Grasso et al., Jun. 16, 2005
20. United States Patent Application 20050119937, Method and System for Generating and Managing Referrals, Anthony D. Estes, Jun. 2, 2005
21. United States Patent Application 20050144499, Information Processor, Information Processing Method and Computer Program, Narahara, Tatsuya et al., Jun. 30, 2005
22. United States Patent Application 20060031510, Methods and Apparatus for Enabling a Dynamic Network of Interactions according to Personal Trust Levels between Interactors, Beck; Christopher Clemmett Macleod et al., Feb. 9, 2006
23. United States Patent Application 20050272413, Method and Computer System for Matching Mobile Device Users for Business and Social Networking, Julian J. Bourne, Dec. 8, 2005
24. United States Patent Application 20060041543, System and Method for Employing Social Networks for Information Discovery, Achlioptas; Dimitris, Feb. 23, 2006
25. An Algorithmic Approach to Social Networks, David Liben-Nowell, June 2005
26. TREF: A Threat-Centric Comparison Framework for Decentralized Reputation Models, Girish Suryanarayana, Richard N. Taylor, January 2006
27. United States Patent Application 20060048059, System and Method for Dynamically Generating, Maintaining, and Growing An Online Social Network, Etkin; Henry, Mar. 2, 2006
28. Information Theoretic Framework of Trust Modelling and Evaluation for Ad Hoc Networks, Yan Lindsay Sun, Wei Yu, Zhu Han, K. J. Ray Liu, February 2006
29. IT-supported Visualization and Evaluation of Virtual Knowledge Communities, Matthias Trier, March 2005
30. United States Patent Application 20050154639, Business Method and Model for Integrating Social Networking into Electronic Auctions and Ecommerce Venues, Karl Douglas Zetmeir, Jul. 14, 2005
31. Learning and Discovery in Incremental Knowledge Acquisition, Hendra Suryanto, January, 2005
32. United States Patent Application 20060074906, Self-organization Approach to Semantic Interoperability in Peer-to-peer Information Exchange, Steels; Luc; et al., Apr. 6, 2006
33. Using Formal Concept Analysis with A Push-based Web Document Management System, Timothy John Everts, November, 2004
34. Collaborative Ontology Building with Wiki agent—A Multi-agent Based Ontology Building Environment, Jie Bao and Vasant Honovar, Jul. 30, 2004
35. Automatic Generation of Thematically Focused Information Portals from Web Data, Sergei Sizov (dissertation), 2005
36. Analysis and Visualization of Network Data using JUNG, Joshua O'Madadhain, Danyel Fisher, Padhraic Smyth, Scott White, Yan-Biao Boey, Vol. VV, Issue II., Journal of Statistical Software, http://www.jstatsoft.org.
37. Emergent Properties of Referral Systems, Pinar Yolum, Munindar P. Singh, Jul. 14-18, 2003, www.csc.ncsu.edu/faculty/mpsingh/papers/mas/aamas-03-emergent.pdf
38. Introduction to Social Network Methods, Robert A. Hanneman and Mark Riddle, 2005, www.bsos.umd.edu/socy/alan/stats/network-ugrad/handouts/Hanneman-Introduction%20to%20Social%20Network%20Methods.pdf
39. United States Patent Application 20060042483, Method and System for Reputation Evaluation of Online Users in A Social Networking Scheme, Work; James Duncan; et al., Mar. 2, 2006
40. The Resource Generator: Social Capital Quantification with Concrete Items, Martin Van Der Gaag, Tom A. B. Snijders, 21 Oct. 2004
41. Position Generator Measures and Their Relationship to Other Social Capital Measures, Martin Van Der Gaag, Tom A. B. Snijders, Henk D. Flap, 20 Oct. 2004
42. A Comparison of Measures for Individual Social Capital, Martin Van Der Gaag, Tom A. B. Snijders, 27 Nov. 2003
43. Measurement of Individual Social Capital, Martin Van Der Gaag, 2005
44. U.S. Pat. No. 4,354,844, Behavioral and Psychological Test Instrument, Ickinger, Oct. 19, 1982
45. Measurement of Social Capital, Reference Document for Public Policy Research, Development, and Evaluation, Sandra Franke, September, 2005
46. Trust in Embedded Settings, Davide Barrera, 2005, ISBN 90-393-4019-6
47. Agent-based Recommender Systems, Olli Niinivaara, May 17, 2004
48. Random Graphs and Complex Networks, Remco van der Hofstad, Jan. 31, 2006
49. Multiscale Visualization of Small World Networks, David Auber, Yves Chiricota, Fabien Jourdan, Guy Melancon, dept-info.labri.fr/˜auber/documents/publi/auberIV03Seattle.pdf.

What is claimed is:

1. A method to establish an online social network for social partnering, comprising
providing an online social network having a plurality of members comprising at least one first member and a group of other members,
classifying attributes of Social Position and of Social Attitudes of each member into sets corresponding to different themes, and
enabling the at least one first member to select candidate partners from the group of other members according to the attributes of Social Position and of Social Attitudes of the at least first member and of each of the other members.

2. The method of claim 1 further comprising
enabling the at least one first member of the online social network to describe his or her capability and social capital in a certain field using a certain Glossary and to use such description as a personal tag in the online social network; and
enabling multiple members of the social network to negotiate the Glossary and the classification of attributes of Social Position and of Social Attitudes using computing terminals and/or communication terminals.

3. The method of claim 1 further comprising
enabling a member of the social network to describe his/her way of social interaction in the clique formed by acquaintances of strong ties, the description able to be used on computing terminals and/or communication terminals to represent the Social Position the member engages in his/her social interactions in the clique formed by acquaintances of strong ties, and
enabling the online social network to collect data related to the interaction mode among members, and to represent the Social Position the member engages in his/her social interactions in the clique formed by acquaintances of weak ties using such data on the computing terminals and/or communication terminals.

4. The method of claim 1 further comprising
enabling a member to generate test questions to elicit reactions from another member under preset situations on computing terminals and/or communication terminals,
enabling evaluation of the reactions to allow at least one second member to estimate the at least one first member's Social Attitude,
enabling the at least one second member, based on the estimate of the at least one first member's Social Attitudes, to make a decision about social partnering for a purpose with said first member, wherein the partnering is related to the theme.

5. The method of claim 1, wherein, the at least first member in the social network is enabled to declare his or her role in social resource provision in a certain field;
the first member can define which other second member and/or other members, and by what criteria, are entitled to information about the first member's capability;
the first member can access resources in the part of the existing social network available to the first member; and
the first member can access a part of the existing social network unknown to the first member previously.

6. The method of claim 1 further comprising
enabling a member to generate test questions to elicit reactions from another member under preset situations on computing terminals and/or communication terminals,
sensing at least one first member's reactions under preset situations of social relations with sensors, wherein the sensors produce transmissible signals corresponding to the reactions,
transmitting the signals within the online social network
enabling evaluation of the signals to allow at least one second member to estimate the at least one first member's Social Attitude,
enabling the at least one second member, based on the estimate of the at least one first member's Social Attitudes, to make a decision about social partnering for a purpose with said first member, wherein the partnering is related to the theme.
